(19) United States
(12) Patent Application Publication
(10) Pub. No.: US 2025/0335280 A1
(43) Pub. Date: Oct. 30, 2025

(54) METHOD, SYSTEM, DEVICE AND MEDIUM FOR VERIFICATION OF SYSTEM DEGRADATION

(71) Applicant: Beijing Zitiao Network Technology Co., Ltd., Beijing (CN)

(72) Inventors: Hongbo Zhang, Beijing (CN); Yuan Wang, Beijing (CN)

(21) Appl. No.: 19/190,432

(22) Filed: Apr. 25, 2025

(30) Foreign Application Priority Data
Apr. 26, 2024 (CN) 202410512336.X

(51) Int. Cl. G06F 11/07

(52) U.S. Cl. CPC G06F 11/0751; G06F 11/0709

(57) ABSTRACT

The embodiments of the disclosure provide a method, a system, a device and medium for verification of system degradation. A specific implementation of the method includes: in response to a degradation verification request sent by a user for a target system, an initiation server executing a corresponding target operation for the target system, and triggering a target event for a verification server that corresponds to the degradation verification request, an event parameter includes a test scene for this verification; in response to the target event, the verification server sending an event type and the test scene to a configuration server; the configuration server calling a test server to execute a function test task for the target system according to the event type and the test scene; the test server sending an execution result to the verification server for determining a verification result of the degradation verification request.

### CROSS-REFERENCE TO RELATED APPLICATION

This application claims priority to Chinese Patent Application No. 202410512336.X filed on Apr. 26, 2024, which is incorporated herein by reference in its entirety.

### FIELD

Embodiments of the present disclosure relate to the field of computer technologies, and in particular, to a method, system, device, and medium for verification of system degradation.

### BACKGROUND

Degradation is to ensure basic availability and stability of a system by reducing specific functions or performance of a computer system when the system or service is faced with load pressure, faults, or other abnormal conditions. The degradation verification refers to, in order to verify the validity of degradation, for example, under a preset condition or a specific scenario, intentionally triggering a degradation mechanism of a system, so as to confirm whether the system can be successfully degraded and whether a core function of the system can continue to work normally after the system is degraded. Conventional degradation verification solutions in the prior art mainly include a user manually initiating a degradation task, and after the degradation task is completed, manually starting, for example, a function test task, so as to verify the effectiveness of the degraded system. However, such a degradation verification solution has a problem that the degradation verification efficiency is low, and a verification frequency for the system under verification in a specific verification period is low.

### SUMMARY

Embodiments of the present disclosure describe a method, system, device, and medium for verification of system degradation.

According to a first aspect, there is provided a method for verification of system degradation, including:
in response to a degradation verification request sent by a user for a target system, executing, by an initiation server, a target operation corresponding to the degradation verification request for the target system, and triggering a target event for a verification server that corresponds to the degradation verification request, a parameter of the target event includes a test scene for this verification; and
in response to the target event, sending, to a configuration server by the verification server, an event type of the target event and the test scene; calling, by the configuration server, a test server to execute a function test task for the target system according to the event type and the test scene; sending, to the verification server by the test server, an execution result of the function test task; determining, by the verification server, a verification result of the degradation verification request at least based on the execution result.

According to a second aspect, there is provided a system for verification of system degradation, including:
an initiation server configured to execute, in response to a degradation verification request sent by a user for a target system, a target operation corresponding to the degradation verification request for the target system, and trigger a target event for a verification server that corresponds to the degradation verification request, a parameter of the target event includes a test scene for this verification;
the verification server is configured to send, in response to the target event, an event type of the target event and the test scene to a configuration server;
the configuration server is configured to call, according to the event type and the test scene, a test server to execute a function test task for the target system;
the test server is configured to send an execution result of the function test task to the verification server;
the verification server is further configured to determine a verification result of the degradation verification request at least based on the execution result.

According to a third aspect, a computer readable storage medium is provided, where a computer program is stored on the storage medium, and when being executed in a computer, the computer program causes the computer to execute the method according to the first aspect.

According to a fourth aspect, an electronic device is provided, including a memory and a processor, where an executable code is stored in the memory, and when executing the executable code, the processor implements the method according to the first aspect.

Embodiments of the present disclosure provide a method, system, device, and medium for verification of system degradation. First, an initiation server may receive a degradation verification request sent by a user for a target system, execute a target operation corresponding to the degradation verification request for the target system, and trigger a target event for a verification server that corresponds to the degradation verification request, where a parameter of the target event includes a test scene of this verification. Then, in response to the target event, the verification server sends an event type of the target event and the test scene to the configuration server. Then, according to the event type and the test scene, the configuration server calls a test server to execute a function test task for an application access interface of the target system and matching the test scene and the event type; the test server sends an execution result of the function test task to the verification server for determining a verification result of the degradation verification request. By means of the method, the efficiency of degradation verification and the verification frequency within a specific verification period can be greatly improved, thereby improving the capability of discovering a system degradation failure by means of degradation verification.

### BRIEF DESCRIPTION OF THE DRAWINGS

FIG. 1 is a schematic diagram illustrating a method for verification of system degradation according to embodiments of the present disclosure;

FIG. 2 is a schematic diagram illustrating determination of a degradation verification result in combination with a function test result and a metric fluctuation trend according to embodiments of the present disclosure;

FIG. 3 illustrates a schematic flowchart of a method for verification of system degradation according to embodiments of the present disclosure;

FIG. 4 illustrates a schematic diagram of post-degradation verification according to embodiments of the present disclosure;

FIG. 5 illustrates a schematic diagram of a degradation recovery degradation recovery according to embodiments of the present disclosure;

FIG. 6 illustrates a schematic diagram of pre-degradation verification according to embodiments of the present disclosure;

FIG. 7 illustrates a schematic block diagram of a system for verification of system degradation according to embodiments of the present disclosure;

FIG. 8 illustrates a structural schematic diagram of an electronic device suitable for implementing embodiments of the present disclosure;

FIG. 9 illustrates a structural schematic diagram of a storage medium suitable for implementing embodiments of the present disclosure.

### DETAILED DESCRIPTION

The technical solutions provided by the present disclosure will be further described in detail below in conjunction with the accompanying drawings and embodiments. It should be understood that the specific embodiments described herein are only used to explain the related invention, rather than limit the present disclosure. In addition, it should be noted that, for ease of description, only parts related to the related invention are shown in the accompanying drawings. It should be noted that the embodiments of the present disclosure and the features of the embodiments can be combined with each other without conflict.

In the description of implementations of the present disclosure, the term “including” and its similar language should be understood as non-exclusive inclusion, that is, “including but not limited to”. The term “based on” should be understood as “based at least in part on”. The term “one implementation” or “the implementation” should be understood as “at least one implementation”. The term “some implementations” should be understood as “at least some implementations”. Other explicit and implicit definitions may also be included below.

As described above, degradation is to ensure basic availability and stability of a system by reducing specific functions or performance of a computer system when the system or service is faced with load pressure, faults, or other abnormal conditions. The degradation verification refers to, in order to verify the validity of degradation, for example, under a preset condition or a specific scenario, intentionally triggering a degradation mechanism of a system, so as to confirm whether the system can be successfully degraded and whether a core function of the system can continue to work normally after the system is degraded. Conventional degradation verification solutions in the prior art mainly include a user manually initiating a degradation task, and after the degradation task is completed, manually starting, for example, a function test task, so as to verify the effectiveness of the degraded system. However, such a degradation verification solution generally has the following problems: on the one hand, the user needs to perform a degradation operation and a verification operation separately; after degradation recovery, a degradation rollback operation generally needs to be manually performed on a system, and a second verification needs to be performed to ensure that a system function is really restored, these steps are complex for the user. On the other hand, it is difficult to avoid the inattentiveness of the operation by relying on manual methods. For example, because of the complexity of steps, after performing verification on the degraded system, the user may forget to roll the system back to the pre-exercise state, which may easily cause the operational risks to the system under test. According to a third aspect, the user operation steps are cumbersome, and the efficiency of degradation verification in a manual manner is low, so that a verification frequency for a system under test within a specific verification period is low.

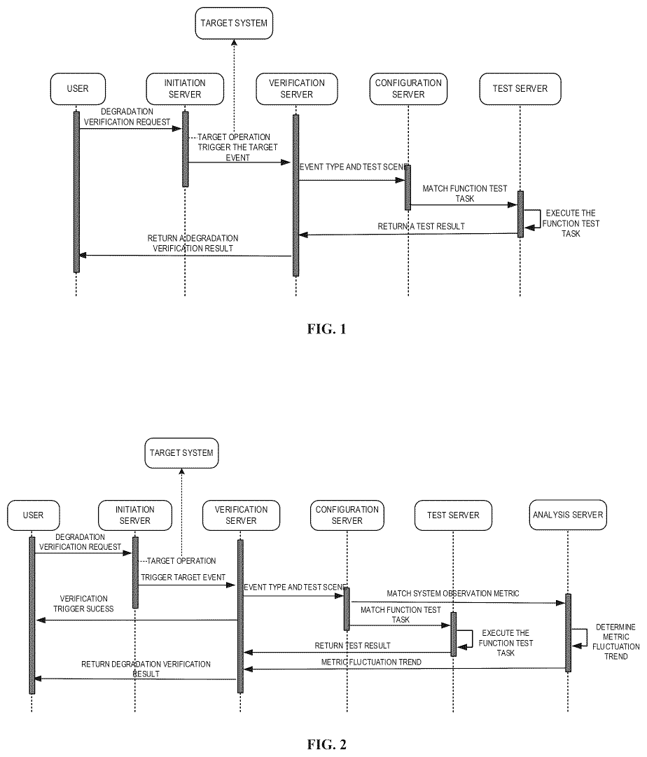

In order to solve the above technical problem, embodiments of the present disclosure provide a method for verification of system degradation. FIG. 1 illustrates a schematic diagram of a method for verification of system degradation according to embodiments of the present disclosure. As shown in FIG. 1, in some embodiments, a user may send a degradation verification request to an initiation server, for example. After receiving the degradation verification request, the server is initiated to execute a target operation on the target system under verification, and a target event for the verification server that corresponds to the degradation verification request is triggered. The verification server receives the target event, and may send the test scene and the event type of the target event included in the parameters of the target event to the configuration server. The configuration server determines a function test task according to the event type and the test scene, and the test server executes the function test task for the application interface of the target system. The test server sends an execution result of the function test task to the verification server, and the verification server may determine a degradation verification result based on the execution result of the function test task and send same to the user. FIG. 2 illustrates a schematic diagram of determining a degradation verification result in combination with a functional test result and an icon fluctuation trend according to embodiments of the present disclosure. As shown in FIG. 2, in some embodiments, a configuration server may further call an analysis server to determine a fluctuation trend of a target observation metric of a target system after the target event, and the analysis server may send the fluctuation trend of the target observation metric to the verification server, so as to determine a degradation verification result in combination with an execution result of a function test task. The method has the advantage that, on the one hand, the user can complete the process from the degradation operation of the system to the system verification automatically by sending a verification request. Not only the user operation is greatly simplified, but also the operation risk due to the inadvertent manual operation is reduced. According to a second aspect, by using the method, the efficiency of degradation verification can be greatly improved, and time consumed by single degradation verification is reduced. Thus, the degradation verification frequency in a specific verification cycle is improved, and the capability of finding degradation faults of a system through degradation verification is greatly improved.

The detailed process of this method is described further below.

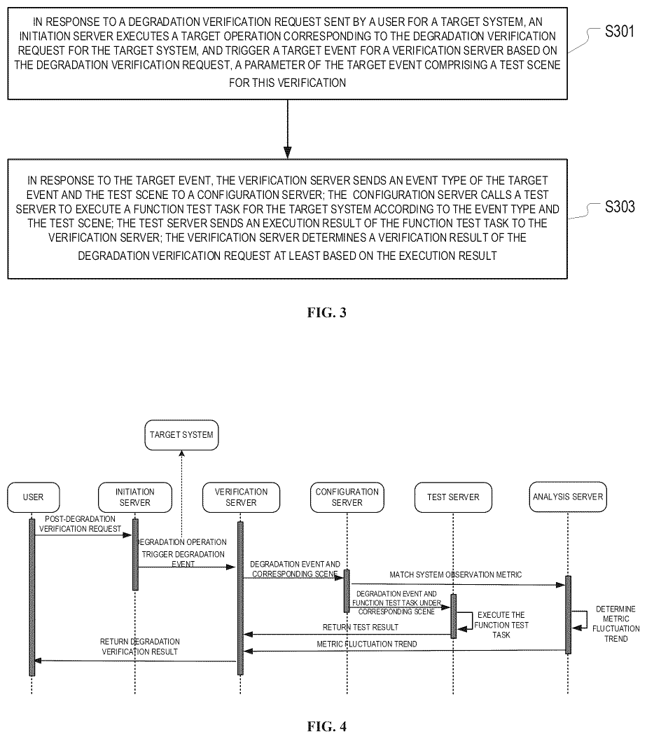

FIG. 3 illustrates a schematic flowchart of a method for verification of system degradation according to embodiments of the present disclosure. As shown in FIG. 3, the method at least includes the following steps:

at step S301, in response to a degradation verification request sent by a user for a target system, an initiation server executes a target operation corresponding to the degradation verification request for the target system, and triggers a target event for a verification server that corresponds to the degradation verification request, where a parameter of the target event includes a test scene of this verification;

at step S303, in response to the target event, the verification server sends an event type of the target event and the test scene to a configuration server; the configuration server, according to the event type and the test scene, calls a test server to execute a function test task for the target system, and the test server sends an execution result of the function test task to the verification server; the verification server determines a verification result of the degradation verification request based at least on the execution result.

First, in step S301, in response to a degradation verification request sent by a user for a target system, an initiation server executes a target operation corresponding to the degradation verification request for the target system, and triggers a target event for a verification server that corresponds to the degradation verification request, where a parameter of the target event includes a test scene of this verification. The initiation server may be a server that receives a user request and initiates a server for a verification process of a target system. In different embodiments, the initiation server may specifically be one of a physical server, a logical server, or a cloud server, or a server in a server set formed by servers of the foregoing types, which is not limited in this description.

In this step, after receiving the degradation verification request sent by the user for the target system, the initiation server may execute a target operation corresponding to the degradation verification request for the target system, and trigger a target event for a verification server that corresponds to the degradation verification request. The target system refers to an application system directed for the degradation verification which implements application functionality through, or at least in part through, a software program. In different embodiments, the target system may be an application system for different specific services or specific purposes, which is not limited in this description. The parameter of the target event may indicate a test scene of this verification. In an embodiment, the test scene of this verification and other parameters (for example, the identifier of the user sending the request) may also be determined according to indication information of the user in the degradation verification request. The specific test scenes indicated by the degradation verification request may differ in different embodiments.

The specific degradation verification requests sent by the user for the target system may differ in different embodiments. FIG. 4 illustrates a schematic diagram of post-degradation verification in accordance with embodiments of the present disclosure. In the embodiment as illustrated in FIG. 4, the degradation verification request may include a post-degradation verification request. Thus, after receiving a post-degradation verification request sent by a user, the initiation server may execute a degradation operation on the target system, and trigger a degradation event for the verification server according to the post-degradation verification request. A degradation operation refers to an operation that worsens a specific function or performance of a system. In different specific embodiments, according to different target systems, specific functions or performance targeted by the degradation operation may be different, which is not limited in this description. For example, in a specific embodiment, the target system may be a video live streaming system. The degradation operation includes a degradation operation for a target video live streaming system of the video live streaming system, and the degradation operation includes reducing an amount of fields of service messages collected from the target live streaming room. By reducing the number of fields of the service message, calculation and network resources consumed for collecting and transmitting field information can be greatly reduced, and the operating pressure of the video live streaming system is reduced. Triggering of the degradation event for the verification server may cause the verification server to initiate verification of the degraded target system. In this embodiment, the room number of the target live streaming room may also be included in the degradation verification request. In this manner, the user may send the degradation verification request, for example, to determine whether the degradation operation takes effect, and whether the system function can run normally.

FIG. 5 illustrates a schematic diagram of a degradation recovery verification according to embodiments of the present disclosure. In the embodiment as shown in FIG. 5, the degradation verification request may include a degradation recovery verification request. Thus, after receiving a degradation recovery verification request sent by the user, the initiation server may execute a degradation rollback operation for the target system, and trigger a rollback event for the verification server according to the degradation recovery verification request. The rollback operation refers to an operation of restoring a target system from a degradant state to a normal state, and triggers a rollback event for the verification server, so that the verification server initiates verification on the target system after rollback. In the foregoing manner, the user may send a degradation rollback verification request, for example, to confirm whether the degradation rollback operation is effective and whether the system function after rollback can be run normally.

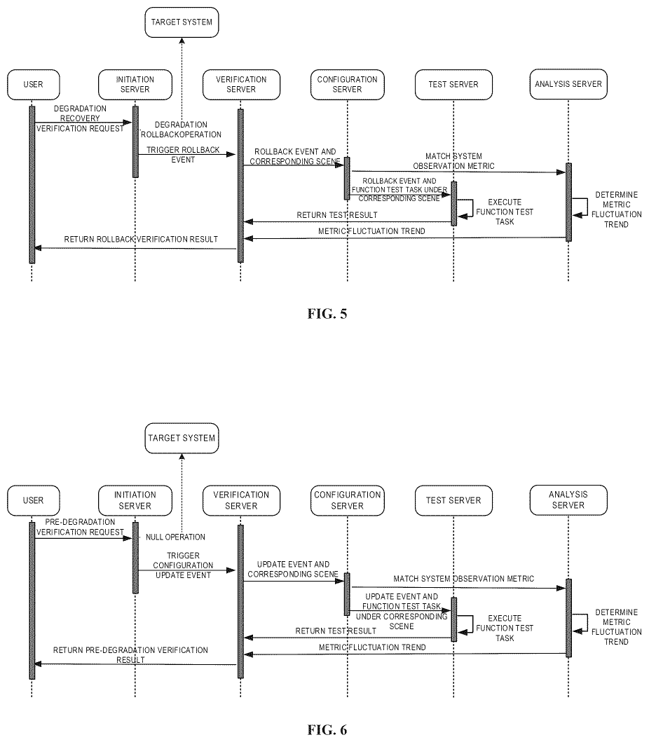

FIG. 6 illustrates a schematic diagram of pre-degradation verification according to embodiments of the present disclosure. In the embodiment shown in FIG. 6, the pre-degradation verification request includes a pre-degradation verification request. Thus, after receiving a pre-degradation verification request sent by a user, the initiation server can execute a null operation for the target system, and trigger a configuration update event for the verification server according to the pre-degradation verification request. In an actual production scenario, with the version or a function iteration for a target system, a configuration for performing verification on the target system is also updated frequently, and a configuration update event for the verification server is triggered, so that the verification server initiates verification on the target system before degradation (i.e., a target system of a current version on which a degradation operation is not applied). In the above manner, the user may, for example, confirm whether the pre-degradation system function can normally operate by issuing a pre-degradation verification request.

Then, at step S303, in response to the target event, the verification server may send an event type of the target event and the test scene to the configuration server. Specifically, the verification server may determine the event type of the target event and the test scene according to the target event and event parameters thereof, and send the event type and the test scene to the configuration server. In order to prompt the user to start the verification, in one embodiment, the verification server may further send a verification trigger success message to the user in response to the target event, as shown in FIG. 2.

After receiving the event type and the test scene, the configuration server may call, according to the event type and the test scene, the test server to execute the function test task for the target system. The function test task refers to a test task for verifying whether each function of the application system is expected to run. In different embodiments, the function test task for the target system may be different. In an embodiment, the function test task may be a function test task for an application programming interface (API) of the target system, or an interface test task for short. In another embodiment, it may also be a function test task for a user interface of a target system, or a UI (User Interface) test task for short. In another embodiment, it may also be a combination of an interface test task and a UI test task.

In different embodiments, the manners of the configuration server call the test server to execute the function test task according to the event type and the test scene may be different. In one embodiment, the configuration server may determine, according to the event type and the test scene, a target test task matching the event type and the test scene from a plurality of function test tasks for an application access interface of the target system, and call the test server to execute the target test task. For example, in a specific example, the target event is, for example, a degradation event, the test scene is, for example, a hot live streaming room, and the configuration server may determine, for example, according to a preset event scene combination and a mapping relationship between the event scene and a test task, a target test task matching the degradation event and the hot live streaming room from a plurality of function test tasks for an application access interface of the target system. By means of the method, a test task corresponding to the target event and the test scene thereof can be automatically matched and executed, thereby reducing the workload of manually matching a test task before each verification.

After the execution of the function test task is completed, the test server may send an execution result of the function test task to the verification server, and the verification server may determine a verification result of the degradation verification request at least based on the execution result.

In order to make a verification result more accurate, in another embodiment, after receiving an event type and a test scene, the configuration server may further call, according to the event type and the test scene, an analysis server to determine a fluctuation trend of a target observation metric of a target system after the target time, and the analysis server sends the fluctuation trend to the verification server. In a specific embodiment, the configuration server may determine, according to the event type and the test scene, a target observation metric matching the event type and the test scene from a plurality of observation metrics for the target system, and call the analysis server to determine the fluctuation trend of the target observation metric after the target event. In turn, the verification server may determine a verification result of the degradation verification request based on the execution result and the fluctuation trend. In this way, the verification server can verify the running state of the target system more accurately in combination with the test result of the application interface of the target system and the viewing result of the data metric of the target system.

In different embodiments, the target observation metrics may also be other specific observation criteria, which is not limited in this description. In the foregoing embodiment of the amount of the degradation field, the target observation metric may be, for example, a total amount of the service fields collected by the system within a unit time. In different embodiments, the specific manner for the verification server determining the verification result may vary. In one example, the verification result may be determined based on, for example, a pass rate of the execution result and whether the fluctuation trend is within a predetermined range.

In one embodiment, after confirming the verification result, the verification server may send a verification result to the user. The results of the verification request may be prompted to the user by sending the verification result, and the user may also be enabled to initiate desired other requests that are associated with the current verification request. In another embodiment, the user desires to issue a pre-degradation verification request, a post-degradation verification request, a post-degradation rollback verification request, for example, in order. In turn, the user may initiate a post-degradation verification request, for example, upon receiving a verification result of the post-degradation verification request.

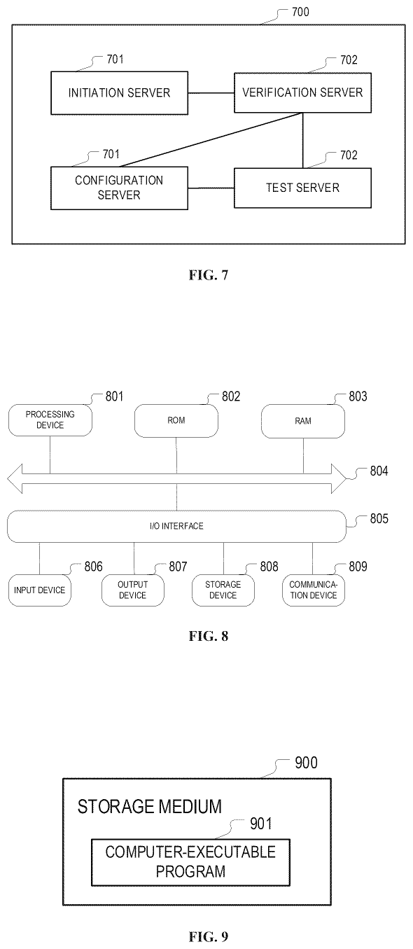

FIG. 7 illustrates a schematic block diagram of a system for verification of system degradation according to embodiments of the present disclosure. As shown in FIG. 7, the system 700 includes:
an initiation server 701 configured to execute, in response to a degradation verification request sent by a user for a target system, a target operation corresponding to the degradation verification request for the target system, and trigger a target event for a verification server that corresponds to the degradation verification request, a parameter of the target event includes a test scene for this verification;
the verification server 702 is configured to send, in response to the target event, an event type of the target event and the test scene to a configuration server;
the configuration server 703 is configured to call, according to the event type and the test scene, a test server to execute a function test task for the target system;
the test server 704 is configured to send an execution result of the function test task to the verification server;
the verification server 704 is further configured to determine a verification result of the degradation verification request at least based on the execution result.

The embodiments of the present disclosure further provide an electronic device, including a memory and a processor. The memory stores an executable code therein. When the processor executes the executable code, the method as shown in FIG. 3 is implemented.

Reference may also be made to FIG. 8, which illustrates a schematic structural diagram of an electronic device 800 suitable for implementing embodiments of the present application. The electronic device 800 shown in FIG. 8 is merely an example and should not bring any limitation to the functions and scope of use of embodiments of the present application.

As shown in FIG. 8, the electronic device 800 may include a processing device (e.g., central processor, graphics processor, etc.) 801. The processing device 801 may be a general processor, a digital signal processor (DSP), a microprocessor, or a microcontroller, and it may further include an Application Specific Integrated Circuit (ASIC), a Field-Programmable Gate Array (FPGA), or other programmable logic device, a discrete gate or transistor logic device and discrete hardware components, It may perform various appropriate actions and processes according to a program stored in a read only memory (ROM) 802 or a program loaded from a storage device 808 into a random access memory (RAM) 803. The RAM 803 also stores various programs and data necessary for the operation of the electronic device 800. The processing device 801, the ROM 802, and the RAM 803 are connected to each other via the bus 804. An input/output (I/O) interface 805 is also connected to bus 804.

In general, the following devices may be connected to the I/O interface 805: input devices 806 including, for example, a touch screen, touch pad, keyboard, mouse, etc.; an output device 807 including, for example, a liquid crystal display (LCD), a speaker, a vibrator, or the like; a storage device 808 including, for example, a magnetic tape, a hard disk, or the like; and a communication device 809. The communication device 809 may allow the electronic device 800 to wirelessly or wired communicate with other devices to exchange data. While FIG. 8 illustrates an electronic device 800 having various devices, it is to be understood that not all of the illustrated means are required to be implemented or provided. More or fewer devices may alternatively be implemented or provided. Each block shown in FIG. 8 may represent a single device or multiple devices as desired.

In particular, according to embodiments of the present application, the processes described above with reference to the flowcharts can be implemented as computer software programs. For example, an embodiment of the present disclosure includes a computer program product including a computer program carried on a computer readable medium. The computer program includes a program code for executing the method as shown in the flowchart. In such an embodiment, the computer program may be downloaded and installed from the network via the communications device 809, installed from the storage device 808, or installed from the ROM 802. When the computer program is executed by the processing device 801, the foregoing functions defined in the method for verification of system degradation provided in this embodiment of the present application are executed.

Embodiments of the present disclosure further provide a computer readable storage medium, on which a computer program is stored. When the computer program is executed in a computer, the computer is enabled to execute a method for verification of system degradation as shown in FIG. 3 provided by the embodiments of the present application. FIG. 9 is a schematic diagram of a storage medium for implementing embodiments of the present application. For example, as shown in FIG. 9, the storage medium 900 may be a non-transitory computer-readable storage medium, configured to store non-transitory computer-executable instructions 901. When the non-transitory computer-executable instructions 901 are executed by the processor, the method for verification of system degradation provided by the embodiment of the present application may be implemented. For example, when the non-transitory computer-executable instructions 901 are executed by the processor, one or more steps of the method for verification of system degradation provided by the embodiment of the present application may be executed. For example, the storage medium 900 may be applied to the foregoing electronic device, and for example, the storage medium 900 may include a memory in the electronic device. For description of the storage medium 900, reference may be made to the description of the memory in the embodiment of the electronic device, and details are not repeatedly described herein. For specific functions and technical effects of the storage medium 900, reference may be made to the description about a method for verification of system degradation provided in the embodiment of the present application, and details are not repeatedly described herein.

It should be noted that, the computer readable medium in the embodiment of the present disclosure may be a computer readable signal medium or a computer readable storage medium, or any combination of the foregoing two. The computer readable storage medium may be, for example, but not limited to, an electronic, magnetic, optical, electromagnetic, infrared, or semiconductor system, apparatus, or device, or any suitable combination of the foregoing. More specific examples of the computer-readable storage medium may include, but are not limited to, an electrical connection having one or more wires, a memory card of a smartphone, a storage component of a tablet computer, a portable computer diskette, a hard disk of a personal computer, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In embodiments of the present disclosure, the computer readable storage medium may be any tangible medium that can contain or store a program, and the program may be used by or in connection with an instruction execution system, apparatus, or device. However, in embodiments of the present disclosure, a computer readable signal medium may include a data signal propagated in a baseband or propagated as part of a carrier wave, in which computer readable program codes are carried. Such a propagated signal may take any of a variety of forms, including, but not limited to, electro-magnetic, optical, or any suitable combination thereof. A computer readable signal medium may also be any computer readable medium that is not a computer readable storage medium and that can send, propagate, or transmit a program for use by or in connection with an instruction execution system, apparatus, or device. Program code embodied on a computer readable medium may be transmitted using any appropriate medium, including, but not limited to, wire, optical fiber cable, RF (Radio Frequency), etc., or any suitable combination of the foregoing.

The computer readable medium may be included in the electronic device, or may exist separately and not be installed in the electronic device. The computer readable medium carries one or more programs. When the one or more programs are executed by the server, the electronic device implements a method for verification of system degradation provided in the embodiments of the present application.

Computer program code for carrying out operations of embodiments of the present disclosure may be written in one or more programming languages or any combination thereof, including an object-oriented programming language such as Java, Smalltalk, C++ or the like and conventional procedural programming languages, such as the “C” programming language or similar programming languages. The program code may be executed entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the drawings illustrate the architecture, functionality, and operation of possible implementations of systems, methods and computer program products according to various embodiments of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the blocks may occur out of the order noted in the drawings. For example, two blocks shown in succession may, in fact, be executed substantially in parallel, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The units involved in the embodiments of the present disclosure may be implemented through software or hardware. The functions described herein above may be performed, at least in part, by one or more hardware logic components. For example, without limitation, example types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Various embodiments in this description are described in a progressive manner, the same or similar parts of the various embodiments may refer to each other, and each embodiment focuses on differences from other embodiments. In particular, for the embodiments of the storage medium and the computing device, since they are basically similar to the method embodiments, the description thereof is relatively simple, and for the relevant parts, reference may be made to the partial description of the method embodiments.

The foregoing description is merely illustrative of the preferred embodiments of the present disclosure and of the technical principles applied thereto, as will be appreciated by those skilled in the art, the disclosure of the present disclosure is not limited to the technical solution formed by the specific combination of the described technical features, it should also cover other technical solutions formed by any combination of the described technical features or equivalent features thereof without departing from the described disclosed concept. For example, the above features and technical features having similar functions disclosed in the present disclosure (but not limited thereto) are replaced with each other to form a technical solution. In addition, while operations are depicted in a particular order, this should not be understood as requiring that the operations are performed in a particular order shown or in sequential order. Multitasking and parallel processing may be advantageous in certain circumstances. Likewise, while several specific implementation details are included in the above discussion, these should not be construed as limiting the scope of the present disclosure. Certain features that are described in the context of separate embodiments can also be implemented in combination in a single embodiment. Conversely, various features that are described in the context of a single embodiment can also be implemented in a plurality of embodiments separately or in any suitable sub-combination thereof.

The objectives, technical solutions, and beneficial effects of the embodiments of the present disclosure are further described in detail in the foregoing specific embodiments. Although the subject matter has been described in language specific to structural features and/or methodological acts, it is to be understood that the subject matter defined in the appended claims is not necessarily limited to the specific features or acts described above. Rather, the specific features and acts described above are merely illustrative forms of implementing the claims. It should be understood that the foregoing descriptions are merely specific implementations of the embodiments of the present disclosure, but are not intended to limit the scope of protection of the present disclosure. Any modification, equivalent replacement, or improvement made on the basis of the technical solutions of the present disclosure shall fall within the scope of protection of the present disclosure.

What is claimed is:

1. A method for verification of system degradation, comprising:
in response to a degradation verification request sent by a user for a target system, executing, by an initiation server, a target operation corresponding to the degradation verification request for the target system, and triggering a target event for a verification server that corresponds to the degradation verification request, a parameter of the target event comprising a test scene for this verification; and
in response to the target event, sending, to a configuration server by the verification server, an event type of the target event and the test scene; calling, by the configuration server, a test server to execute a function test task for the target system according to the event type and the test scene; sending, to the verification server by the test server, an execution result of the function test task; determining, by the verification server, a verification result of the degradation verification request at least based on the execution result.

2. The method of claim 1, further comprising:
calling, by the configuration server and according to the event type and the test scene, an analysis server to determine a fluctuation trend of a target observation metric of the target system after the target event, and sending, by the analysis server, the fluctuation trend to the verification server;
determining, by the verification server, the verification result of the degradation verification request at least based on the execution result comprising:
determining, by the verification server, the verification result of the degradation verification request based on the execution result and the fluctuation trend.

3. The method of claim 2, wherein calling, by the configuration server, the analysis server to determine the fluctuation trend of the target observation metric of the target system after the target event according to the event type and the test scene comprising:
determining, by the configuration server according to the event type and the test scene, a target observation metric matching the event type and the test scene from a plurality of observation metrics for the target system, and calling the analysis server to determine the fluctuation trend of the target observation metric after the target event.

4. The method according to claim 1, wherein calling, by the configuration server, the test server to execute the function test task for the target system according to the event type and the test scene comprises:
determining, by the configuration server according to the event type and the test scene, a target test task matching the event type and the test scene from a plurality of function test tasks for an application access interface of the target system, and calling the test server to execute the target test task.

5. The method of claim 1, wherein the degradation verification request comprises a post-degradation verification request,
receiving the degradation verification request sent by the user for the target system, executing the target operation corresponding to the degradation verification request for the target system, and triggering the target event for the verification server that corresponds to the degradation verification request comprises: receiving the post-degradation verification request sent by the user, executing a degradation operation for the target system, and triggering a degradation event for the verification server according to the post-degradation verification request.

6. The method of claim 1, wherein the degradation verification request comprises a degradation recovery verification request,
receiving the degradation verification request sent by the user for the target system, executing the target operation corresponding to the degradation verification request for the target system, and triggering the target event for the verification server that corresponds to the degradation verification request comprises: receiving the degradation recovery verification request sent by the user, executing a degradation rollback operation for the target system, and triggering a rollback event for the verification server according to the degradation recovery verification request.

7. The method of claim 1, wherein the degradation verification request comprises a pre-degradation verification request,
receiving the degradation verification request sent by the user for the target system, executing the target operation corresponding to the degradation verification request for the target system, and triggering the target event for the verification server that corresponds to the degradation verification request comprises: receiving the pre-degradation verification request sent by the user, executing a null operation for the target system, and triggering a configuration update event for the verification server according to the pre-degradation verification request.

8. The method of claim 1, further comprising,
after confirming the verification result, sending, by the verification server, the verification result to the user.

9. The method of claim 1, wherein calling the test server to execute the function test task for the target system comprises: calling the test server to execute a function test task for an application access interface of the target system.

10. The method of claim 1, wherein the target system is a video live streaming system, the degradation operation comprises a degradation operation for a target live streaming room of the video live streaming system, and the degradation operation comprises reducing an amount of fields of service messages collected from the target live streaming room.

11. A system for verification of system degradation, comprising:
an initiation server configured to execute, in response to a degradation verification request sent by a user for a target system, a target operation corresponding to the degradation verification request for the target system, and trigger a target event for a verification server that corresponds to the degradation verification request, a parameter of the target event comprise a test scene for this verification;
the verification server is configured to send, in response to the target event, an event type of the target event and the test scene to a configuration server;
the configuration server is configured to call, according to the event type and the test scene, a test server to execute a function test task for the target system;
the test server is configured to send an execution result of the function test task to the verification server;
the verification server is further configured to determine a verification result of the degradation verification request at least based on the execution result.

12. A non-transitory computer readable storage medium having a computer program stored thereon, the computer program, when executed in a computer, causing the computer to perform acts comprising:
in response to a degradation verification request sent by a user for a target system, executing, by an initiation server, a target operation corresponding to the degradation verification request for the target system, and triggering a target event for a verification server that corresponds to the degradation verification request, a parameter of the target event comprising a test scene for this verification; and
in response to the target event, sending, to a configuration server by the verification server, an event type of the target event and the test scene; calling, by the configuration server, a test server to execute a function test task for the target system according to the event type and the test scene; sending, to the verification server by the test server, an execution result of the function test task; determining, by the verification server, a verification result of the degradation verification request at least based on the execution result.

13. The non-transitory computer readable storage medium of claim 12, wherein the acts further comprise:
calling, by the configuration server and according to the event type and the test scene, an analysis server to determine a fluctuation trend of a target observation metric of the target system after the target event, and sending, by the analysis server, the fluctuation trend to the verification server;
determining, by the verification server, the verification result of the degradation verification request at least based on the execution result comprising:
determining, by the verification server, the verification result of the degradation verification request based on the execution result and the fluctuation trend.

14. The non-transitory computer readable storage medium of claim 13, wherein calling, by the configuration server, the analysis server to determine the fluctuation trend of the target observation metric of the target system after the target event according to the event type and the test scene comprising:
determining, by the configuration server according to the event type and the test scene, a target observation metric matching the event type and the test scene from a plurality of observation metrics for the target system, and calling the analysis server to determine the fluctuation trend of the target observation metric after the target event.

15. The non-transitory computer readable storage medium according to claim 12, wherein calling, by the configuration server, the test server to execute the function test task for the target system according to the event type and the test scene comprises:
determining, by the configuration server according to the event type and the test scene, a target test task matching the event type and the test scene from a plurality of function test tasks for an application access interface of the target system, and calling the test server to execute the target test task.

16. The non-transitory computer readable storage medium of claim 12, wherein the degradation verification request comprises a post-degradation verification request,
receiving the degradation verification request sent by the user for the target system, executing the target operation corresponding to the degradation verification request for the target system, and triggering the target event for the verification server that corresponds to the degradation verification request comprises: receiving the post-degradation verification request sent by the user, executing a degradation operation for the target system, and triggering a degradation event for the verification server according to the post-degradation verification request.

17. The non-transitory computer readable storage medium of claim 12, wherein the degradation verification request comprises a degradation recovery verification request,
receiving the degradation verification request sent by the user for the target system, executing the target operation corresponding to the degradation verification request for the target system, and triggering the target event for the verification server that corresponds to the degradation verification request comprises: receiving the degradation recovery verification request sent by the user, executing a degradation rollback operation for the target system, and triggering a rollback event for the verification server according to the degradation recovery verification request.

18. The non-transitory computer readable storage medium of claim 12, wherein the degradation verification request comprises a pre-degradation verification request,
receiving the degradation verification request sent by the user for the target system, executing the target operation corresponding to the degradation verification request for the target system, and triggering the target event for the verification server that corresponds to the degradation verification request comprises: receiving the pre-degradation verification request sent by the user, executing a null operation for the target system, and triggering a configuration update event for the verification server according to the pre-degradation verification request.

19. The meth non-transitory computer readable storage medium od of claim 12, wherein the acts further comprise:
after confirming the verification result, sending, by the verification server, the verification result to the user.

20. An electronic device, comprising a memory and a processor, the memory storing an executable code, the processor, when executing the executable code, implementing acts comprising:
in response to a degradation verification request sent by a user for a target system, executing, by an initiation server, a target operation corresponding to the degradation verification request for the target system, and triggering a target event for a verification server that corresponds to the degradation verification request, a parameter of the target event comprising a test scene for this verification; and
in response to the target event, sending, to a configuration server by the verification server, an event type of the target event and the test scene; calling, by the configuration server, a test server to execute a function test task for the target system according to the event type and the test scene; sending, to the verification server by the test server, an execution result of the function test task; determining, by the verification server, a verification result of the degradation verification request at least based on the execution result.
